(19) United States
(12) Patent Application Publication
(10) Pub. No.: US 2025/0293963 A1
(43) Pub. Date: Sep. 18, 2025

(54) DATA-AWARE WORKLOAD PLACEMENT USING REINFORCEMENT LEARNING

(71) Applicant: Dell Products L.P., Round Rock, TX (US)

(72) Inventors: Claudio Romero, Rio de Janeiro (BR); Eduardo Vera Sousa, Niterói (BR)

(21) Appl. No.: 18/602,188

(22) Filed: Mar. 12, 2024

(51) Int. Cl. H04L 43/0876; H04L 41/122; H04L 41/16; H04L 41/5003

(52) U.S. Cl. CPC H04L 43/0876; H04L 41/122; H04L 41/16; H04L 41/5003

(57) ABSTRACT

Multi-agent reinforcement learning-based workload placement and workload placement training is disclosed. A placement engine is configured to use the state of a system and actual rewards to generate expected rewards that correspond to actions. Agents can take actions for corresponding workloads based on the expected rewards output by the placement engine. This allows workloads to be placed in a manner that conserves power relative to load placement policies while helping avoid service level agreement violations. The placement engine, which includes a reinforcement learning engine is trained using lookup tables that include time estimates. The time estimates include estimated execution times and estimated data movement times. The lookup table allows training to be performed using the lookup table instead of actually moving the data and/or performing the execution on the nodes of the computing environment.

### RELATED APPLICATIONS

This application is related to U.S. Ser. No. 17/811,693, filed Jul. 11, 2022, and entitled SWARM MULTI-AGENT REINFORCEMENT LEARNING-BASED PIPELINE FOR WORKLOAD PLACEMENT and U.S. Ser. No. 18/157,168, filed Jan. 20, 2023, and entitled WARM-UP TABLE FOR FAST REINFORCEMENT LEARNING MODEL TRAINING (These applications are referred to herein as MULTI-AGENT REINFORCEMENT). The foregoing applications are incorporated by reference in their entirety.

### FIELD OF THE INVENTION

Embodiments of the present invention generally relate to placing workloads in a computing environment. More particularly, at least some embodiments of the invention relate to systems, hardware, software, computer-readable media, and methods for placing workloads in an infrastructure while respecting data location, data dependency, service level agreements (SLAs) and/or ensuring quality of service (QoS) and more particularly to training models for placing workloads in the infrastructure in a manner that accounts for dataset movement time and workload execution time.

### BACKGROUND

Cloud computing has several advantages, which include pay-per-use computation or subscription use from the customer's perspective and resource sharing/allocation from the provider's perspective. Using virtualization, it is possible to abstract a pool of computing devices to offer computing resources to users (e.g., consumers or customers) that are tailored to the needs of the users. Using various abstractions such as containers and virtual machines, it is possible to offer computation services without the user knowing what infrastructure is executing the user's code. These services may include Platform as a Service (PaaS) and Function as a Service (FaaS) paradigms.

In these paradigms, the QoS expected by the user may be expressed through SLAs. SLAs often reflect expectations such as response time, execution time, uptime percentage, and/or other metrics. Providers try to ensure that they comply with the SLAs in order to avoid contractual fines and to preserve their reputation as an infrastructure provider.

Providers are faced with the problem of ensuring that they comply with the contractual agreements (e.g., SLAs) to which they have agreed. Providers may take different approaches to ensure they comply with their contractual agreements. In one example, a provider may dedicate a static amount of resources to each user. This presents a couple of problems. First, it is problematic to assume that an application is bounded by one particular resource. Some applications may have an IO (Input/Output) intensive phase followed by a compute-intensive phase. Dedicating some amount of static resources to each user may result in inefficiencies and idle resources. Further, it is possible that the initial allocation of resources may be under-estimated or over-estimated.

Allocating excessive resources may also adversely impact the provider. From the perspective of a single workload, the provider may perform the workload and easily comply with the relevant SLAs. However, the number of users that can be served by the provider is effectively reduced because the amount of spare (or unallocated) resources dictates how many workloads can be performed in parallel while still respecting the SLAs. As a result, allocating excessive resources to a single workload impacts the overall efficiency and may limit the number of workloads the provider can accommodate.

While SLAs are often determined in advance of performing a workload, the execution environment is more dynamic. New workloads may compete for computing resources, and this may lead to unplanned demand, which may disrupt the original workload planning because of a greater need to share resources, workload priorities, and overhead associated with context switching.

The challenge facing providers is to provide services to their users in a manner that respects SLAs while minimizing resource usage. Stated differently, providers are faced with the challenge of efficiently using their resources to maximize the number of users.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings, in which:

FIG. 1A discloses aspects of allocating workloads in a computing system or in computing resources;

FIG. 1B discloses additional aspects of training a reinforcement learning model using lookup tables rather than actual workload executions;

FIG. 2 discloses aspects of a reward used in reinforcement learning;

FIG. 3 discloses aspects of training a reinforcement learning model including generating a warm-up table storing at least one metric;

FIG. 4 discloses aspects of training a reinforcement learning model that accounts for data dependencies and/or data locations;

FIG. 5 discloses aspects of a data dependency map and a data location map;

FIG. 6 discloses additional aspects of a lookup table for use at least in training machine learning models such as reinforcement learning models;

FIG. 7 discloses aspects of training a reinforcement learning model using a warm-up table;

FIG. 8 discloses aspects of training a reinforcement learning model to place workloads in an environment; and

FIG. 9 discloses aspects of a computing device, system, or entity.

### DETAILED DESCRIPTION OF SOME EXAMPLE EMBODIMENTS

Embodiments of the present invention generally relate to training models, such as reinforcement learning models. More particularly, at least some embodiments of the invention relate to systems, hardware, software, computer-readable media, and methods for training models in the context of applications such as, but not limited to, workload allocation or workload placement in computing environments or infrastructure. More specifically, embodiments of the invention relate to training a model, such as a reinforcement learning model, to allocate workloads in a computing environment while accounting for aspects of workload execution, data location, and data movement (e.g. from one node/storage/server to another).

Using an infrastructure efficiently to execute workloads or jobs while respecting Service Level Agreements (SLAs) and, thereby guaranteeing Quality of Service (QoS), poses several challenges. As previously stated, service level agreements are often set before the execution of a workload, but the execution environment is subject to several possible disturbances such as poor knowledge about actual resource needs, demand peaks, hardware malfunctions, and others. The challenge is greater in data center environments where the configuration of the nodes may differ and there may be restrictions over gathering information for managing and orchestrating resources. These challenges are further complicated by the fact that workloads have different bottlenecks and because the execution environment can impact performance.

Workloads that are stateful or data-heavy complicate workload execution at least because moving the dataset required by the workload from one node to another node can impact QoS from both network and infrastructure perspectives. Embodiments of the invention relate to workload placement in the context of data dependencies, data location, data execution and/or data movement. Embodiments of the invention further relate to minimizing or reducing SLA violations.

MULTI-AGENT REINFORCEMENT disclosed a multi-agent reinforcement learning-based solution for stateless workload placement, where each workload is associated with an agent. Because all of the agents are similar and independent and use the same model (i.e., shared knowledge of rewards per action in a state), swarm behavior could be leveraged. In addition, in MULTI-AGENT REINFORCEMENT, response times provided by workload-state pairs was generated using a lookup table (or tensor). This tensor-based solution considerably reduced the time needed to train the model and demonstrated that the development and training of a model is feasible even in environments with multiple workloads. MULTI-AGENT REINFORCEMENT, however, assumed negligible data movement in some examples.

Embodiments of the invention relate to allocating workloads in a manner that further accounts for data dependencies and/or data location using a workload dependency and location representation, such as a data dependency map and a data location map. These maps allow data currently present in an infrastructure to be identified and located.

In an example computing environment, deciding to move a workload from one node to another mode may need to account for the need or request to also move a dataset, which may be affected by the data's location which is provided by the workload dependency representations expressed in the data dependency map and the data location map.

More specifically, in addition to aspects of workload execution, embodiments of the invention may employ a data dependency map and a data location map. These maps allow the location of each dataset in the computing environment to be updated, in real-time, during the allocation operation while minimizing or reducing the overall execution time of the workload.

This allows an additional reward to be determined form both workload placement, workload execution, and/or data location, according to data availability on a given node or in the nodes of the computing environment. A lookup table is generated that includes estimated times. The estimated times include, in one example, estimated data movement times (e.g., time to download datasets to a node), and estimated workload execution times. The lookup table can be used when training a reinforcement learning model to generate rewards immediately rather than waiting for a dataset to be downloaded and waiting for the workload to execute. In other words, embodiments of the invention relate to training a model using estimated times such that the training operation does not need to wait for the actual time required to download datasets/execute workloads.

In one example, the dataset required by a particular workload is provided by or identified in the data dependency map. The location of the dataset is identified in the data location map.

To generate the estimated time (e.g., mean times) lookup table, several tensors may be generated. For example, tensors for estimated execution times, dataset dependencies, dataset locations, and download times may be generated. These tensors may be combined or used to generate an estimated time tensor or estimated time lookup table.

Embodiments of the invention thus relate to estimating or determining the time needed to both transfer required datasets to a node and execute the workload on that node. In the training operation, reinforcement learning agents are responsible for both the data movement tasks and the workload placement tasks and all the agents work in a cooperative way to improve the overall reward.

Embodiments of the invention relate to a data-aware placement engine that includes, in one example, multi-agent reinforcement learning that considers workload execution, data location, and/or data movement requirements.

Training the placement engine is achieved, at least in part, using tensors including a data dependency map and a data location map. These maps allow the location of each dataset to be updated, in real-time, during a placement or allocation operation while minimizing or reducing the overall execution time of the workload.

The estimated time lookup table may include or relate to a probability distribution for various computations (e.g., workload execution times and data movement times). This allows the training operation to be performed more quickly because the information needed to generate or determine rewards can be determined from or sampled from the probability distribution, which may be represented as a lookup table. The conventional need to wait for the computation metrics, which time may be significant, is avoided. Thus, the time required to train a model such as a reinforcement model is reduced.

Embodiments of the invention more specifically relate to and are described in the context of training models to allocate (or place) workloads (e.g., recommend allocation actions) in a computing environment. Embodiments of the invention, however, may be implemented in other applications and systems. Embodiments of the invention further relate to reducing the time required to train a model and compensate for the exploration/exploitation trade-off experienced when randomly exploring different unknown actions/states.

Models such as reinforcement learning models can be trained to allocate workloads (e.g., place, migrate, remove workloads and/or move datasets) to resources as required in order to comply with SLAs and to efficiently use resources of the computing environment. In one example, allocating workloads is achieved by placing workloads in specific resources (e.g., nodes) and ensuring that the required datasets are present on those nodes. This may include migrating the workloads from one location to another location and moving datasets from one location to another location. Workloads are allocated such that SLAs are respected, to cure SLA violations, and/or such that the resources of the provider are used beneficially from the provider's perspective. One advantage of embodiments of the invention is to allow a provider to maximize use of their resources.

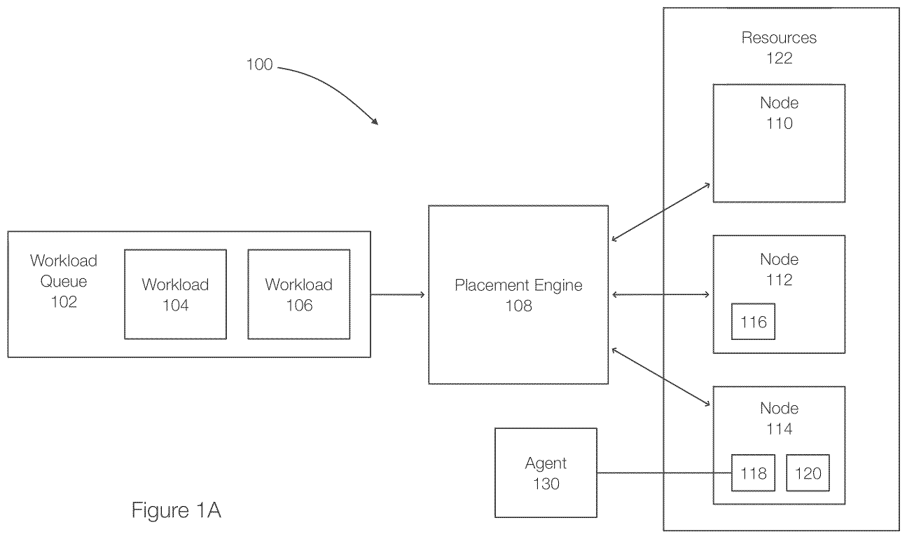

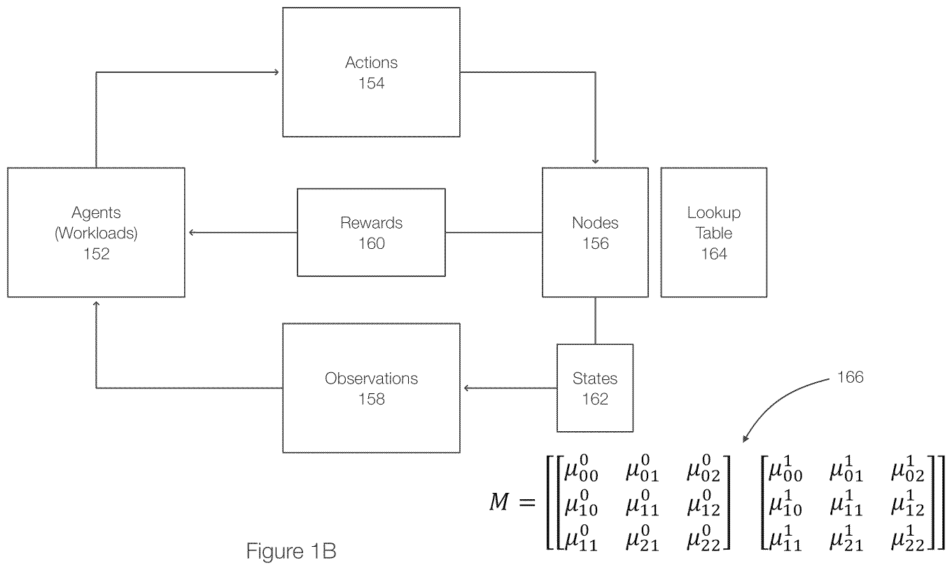

Prior to discussing aspects of training a reinforcement learning model, a description of an operating reinforcement learning model is described. FIG. 1A discloses aspects of reinforcement learning based workload allocation in a computing environment. A system 100 (e.g., a datacenter or other computing environment/infrastructure) may include resources 122. The resources 122, alternatively, may represent geographically distributed resources (e.g., one or more edge systems, one or more datacenters or combinations thereof). The resources 122 may include nodes, which are represented by the nodes 110, 112, and 114. Nodes may each include a computing device or system with processors, memory, network hardware, and the like. The nodes 110, 112, and 114 may include physical machines, virtual machines, containers, and the like. Workloads are typically assigned to computers, containers, or virtual machines operating or included in the nodes 110, 112, and 114.

The resources 122 of the system 100 may be used to execute or perform workloads. In other words, the system 100 allocates the workloads to or in the resources 122 such that the workloads are executed in the resources 122. Allocating a resource may include placing a workload at a node (e.g., at a virtual machine on the node) and/or migrating a workload from one node to another node or from one virtual machine to another virtual machine.

The following discussion assumes that workloads are performed or executed by virtual machines and that each of the nodes 110, 112, and 114 may support one or more virtual machines. Further, each virtual machine may perform or execute one or more workloads of one or more types. Example workload types include, but are not limited to, central processing unit (CPU) bound workloads and graphics processing unit (GPU) bound workloads.

The system 100 may include or have access to a workload queue 102 that stores workloads, represented by the workloads 104 and 106. When a user or application submits a workload, the workload may be stored in the workload queue 102 and then allocated in the resources 122.

The system 100 may also include a placement engine 108, which may also operate on a node or server. The placement engine 108 may include or represent a machine learning model. In one embodiment, the placement engine 108 may include a reinforcement learning model configured to generate allocation recommendations or actions for workloads executing in the resources 122. The allocation recommendations may have different forms. For example, the allocation recommendations may be in the form of a reward if a certain action is performed. The action associated with the highest reward available or expected may be output by the placement engine 108 and is typically performed.

FIG. 1A illustrates that a workload 116 has been placed at the node 112 and that workloads 118 and 120 have been placed at the node 114. More specifically, the workload 116 may be performed by a virtual machine instantiated on the node 112 and the workloads 118 and 120 may be performed by one or more virtual machines instantiated on the node 114. These workloads 116, 118, and 120 were placed, in one example, by an agent based on recommendations of the placement engine 108. In one example, the agent and workload are the same.

The placement engine 108 may include a trained reinforcement learning model that receives, as input, the state of the resources 122 as well as a reward associated with the execution of the workloads 116, 118, and 120 to generate new allocation recommendations. This may result in the migration of one or more of the workloads 116, 118, and 120 to different virtual machines or to a different portion of the resources 122. When migration is recommended, embodiments of the invention may also account for and perform dataset movement (e.g., moving a dataset from one node to another node).

The placement engine 108, once trained, thus makes allocation decisions or allocation recommendations. Allocation decisions or recommendations may include placing a new workload at a node or a virtual machine, moving or migrating a workload from a current node or virtual machine to a different node or virtual machine, and keeping a workload at the same node or virtual machine.

An agent, by way of example, may be a component or engine that operates in a computing environment to perform actions, communication, or the like. An agent may thus generate goals, perform actions, sense the environment, determine status of a computing system, learn, or the like or perform other aspects of reinforcement learning.

FIG. 1A illustrates an agent 130 associated with a workload 118. In one embodiment, each of the workloads 116, 118, 120 executing in the resources 122 is associated with a different agent. At the same time, all of the agents in the system 100 use the same placement engine 108 (or reinforcement learning model). This allows swarm behavior for the agents where each of the agents is associated with a different workload while using the same placement engine 108. As previously stated, the agent/workload may be the same.

FIG. 1B discloses additional aspects of workload placement using multi-agent reinforcement learning. In this example, each of the agents 152 is associated with a workload to be executed. Each of the nodes 156, which may support one or more virtual machines, capable of running a workload is defined as a state. Collectively, the nodes 156 have corresponding states 162. Each state may have different features (e.g., number of central processing unit cores, memory availability, presence of a graphics processing unit, or the like).

The reinforcement learning model is being trained to define a best workload-node (or device or virtual machine) association, given an evaluation metric such as response time. The evaluation metrics associated with executing the workloads 152 at the nodes 156 may be translated into rewards 160. The overall reward is provided as a summation of the rewards per agent. The observations 158 include, in one example, a one-hot encoding that includes available resources and lifetime or each workload at each of the devices or nodes 156. The one-hot encoding may include the states of the nodes 156.

In one example, the action space is defined by integer values that represent the index of the virtual machines (or nodes 156) where the workloads 152 can be placed. Given a workload placed at a node or VM vᵢ in an environment with n nodes or VMs, the available actions are:
Move the workload to the VM vⱼ, with j≠i and 0<j≤n; and
Keep the workload in vᵢ.

Each of the agents 152 is able to view or see the entire infrastructure of the nodes 156 as a modified version of one-hot encodings (the observations 158), where each bin includes float values with the following telemetries:
Resource usage per VM;
Resource usage per workload;
State of each workload; and
How long it will take to finish each workload.

An example reward function in this example may be defined as follows:

$$f ( Δ , {σ}_{L} , {σ}_{R} ) = \frac{- {( Δ )}^{2}}{{e}^{2 {σ}_{L}^{2}}}$$

$$if Δ > 1 , otherwise$$

$$\frac{- {( Δ )}^{2}}{{e}^{2 {σ}_{L}^{2}} - 1} .$$

In one example embodiment, Δ is a difference between the SLA and the response time. In one example, σ_{L}, σ_{R} define, respectively, how fast the left and right portion of the curve decays.

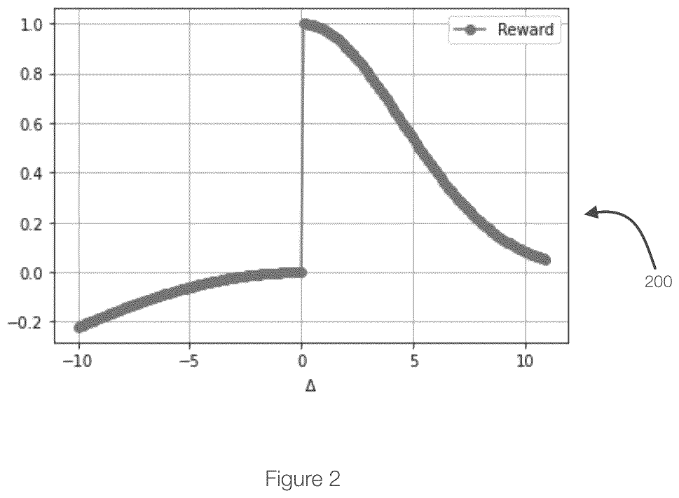

FIG. 2 discloses aspects of a reward curve. More specifically, the curve 200 is an example of a reward curve where σ_{L}=2 and σ_{R}=0.75. In this example, there are several possibilities for the value of A:
1) Δ>0→SLA>rt: In this case, there is a positive gap between the SLA and the value of the response time (rt). This indicates that resources are being wasted and should provide a positive reward.
2) Δ<0→SLA<rt: In this case, there is a negative gap between the SLA and the response time. This indicates an SLA violation and should provide a negative reward.
3) Δ=0→SLA=rt: In this case, there is no gap between the SLA and the response time. This indicates that the workload fits perfectly with the infrastructure and a maximum reward should be provided.

When training a model to place workloads in the nodes 156, embodiments of the invention use a lookup table rather than actual workload execution at the nodes. Thus, rather than execute the workloads in the nodes 156, a lookup table 164 (a tensor) is used to determine or estimate the workload execution time and thereby generate the rewards 160.

More specifically, the lookup table 164, which stores estimated or mean execution times, allows the need to execute workloads during reinforcement learning training to be avoided. In one example, execution times of multiple combinations of workload instances, of each workload type, on each of the nodes 156 may be determined in advance. This information is used to generate seeds (e.g., mean and standard deviation) that can be included in the lookup table 164. Stated differently, statistical data is collected to build the lookup table 164 such that the execution time of a given type of workload considering a given number of parallel executions at a given node, can be estimated. This reduces the exploration time of the agents by not running the workload repeatedly during the training phase and can substantially reduce the overall time required to train the reinforcement learning model.

The lookup table 164 is constructed, in one example, as a rank-k tensor where (k−1) dimensions represent the number of instances and 1 dimension represent the workload type. Thus, considering an embodiment where there are two possible types of workloads running in an infrastructure such as the nodes 156 (type 0 and type 1), the element μ_{{1,3}}⁰, for example, refers to the mean execution time of a workload of type 0 when there is 1 instance of workload type 0 and 3 instances of workload type 1 on the node (or virtual machine). One of the possible embodiments of this tensor is represented below and illustrated as the lookup table 166. This tensor or lookup table 166 (the same as the lookup table 164 in this example) represents a situation where there are two possible types of workloads and up to 2 instances of each. However, the maximum of instances may be defined by the capacity of a given node to run this number of workloads.

Thus, an example lookup table 166 may be

$$M = [ [ \begin{matrix}{μ}_{00}^{0} & {μ}_{01}^{0} & {μ}_{02}^{0} \\ {μ}_{10}^{0} & {μ}_{11}^{0} & {μ}_{12}^{0} \\ {μ}_{11}^{0} & {μ}_{21}^{0} & {μ}_{22}^{0}\end{matrix} ] [ \begin{matrix}{μ}_{00}^{1} & {μ}_{01}^{1} & {μ}_{02}^{1} \\ {μ}_{10}^{1} & {μ}_{11}^{1} & {μ}_{12}^{1} \\ {μ}_{11}^{1} & {μ}_{21}^{1} & {μ}_{22}^{1}\end{matrix} ] ]$$

as illustrated in FIG. 1B.

In this example, an additional dimension may be added to represent the nodes. Thus, M=[M⁰, M¹, . . . , Mⁿ], where n is the number of nodes. Each slice of the lookup table M 166 corresponds to a specific node included in the nodes 156.

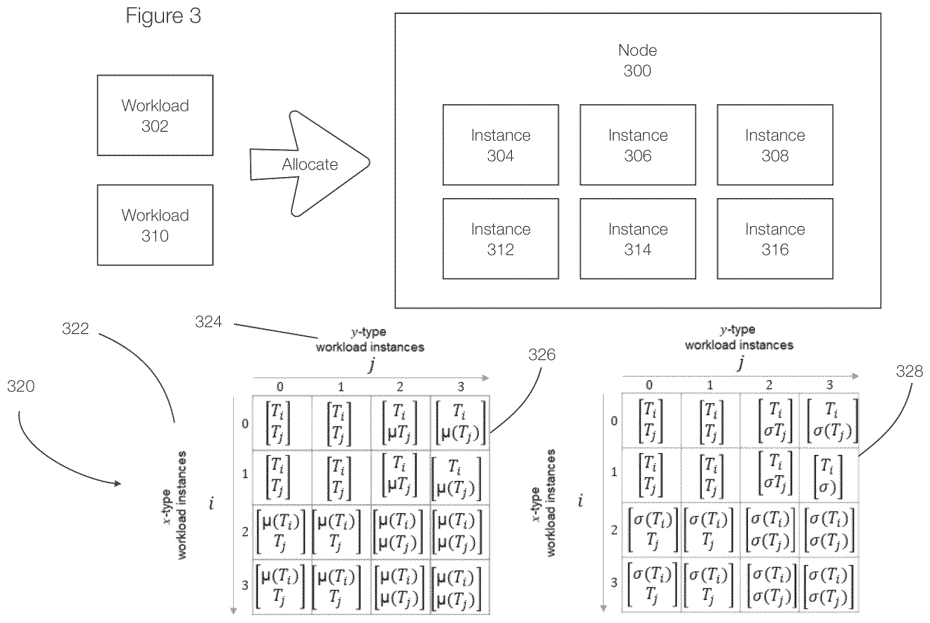

FIG. 3 discloses aspects of generating a warm-up table that can be used in training a machine learning model such as a reinforcement learning model. FIG. 3 uses a lookup table such as the lookup table 166. Thus, the table 320 is an example of the lookup table 166. FIG. 3 illustrates workloads 302 and 310. The workload 302 is a type x workload (e.g., CPU bound) and the workload 310 is a type y workload (e.g., GPU bound). FIG. 3 illustrates a node 300 (or virtual machine) that may be configured to execute instances of the workloads 302 and 310.

For example, up to three instances of each of the workload types x and y (302 and 310) may be instantiated or executed on the node 300. More specifically, during an offline stage, various metrics such as execution time or response time or the like may be collected by performing executions. This type of data is generated or collected in order to generate a lookup table 320, which is an example of a warm-up table for reinforcement learning operations.

When generating the table 320, metrics for various combinations of workload instances may be collected. In this example, the workload instances 304, 306, and 308 of the workload 302 are of type x and the workload instances 312, 314, and 316 of the workload 310 are of type y.

The table 320 represents the various combinations of workload instances that may be executed on the node 300. The table 320 is a rank 3 tensor with the form (i, j, t), where the first two dimensions represent the combination of ij workload instances of t types of workloads. The two slices of the last dimension present the samples of each workload type.

In this example, the table 320 includes two tensors for the node 300. The first tensor 326 contains information on the averages (average execution times) and the second tensor 328 includes information on the standard deviations. In the tensors 326 and 328, T; corresponds to the execution time of workload instance type x and T; corresponds to the execution time of workload instances of type y. The table 320 thus represents a probability distribution of runtimes of different instances of both workload types. In one example, in order to avoid capturing outlier data on the execution times, T, and T; are the mean times of 100 workload runs in one example.

A lookup table 320 (each slice of the tensor corresponds to a node) may be generated for each node in the learning environment. The table 320 can be expanded to multiple nodes as required. Even though the offline computation time is increased as it may be necessary to measure the execution times in this example, the time spent exploring by agents when training the reinforcement learning model is decreased as execution times may be obtained from the lookup table 320.

In one example, a multi agent reinforcement learning method or model is being trained in an environment where the reward function depends at least on the execution times of I instances of T types of workloads. Embodiments of the invention generate a warm-up table as described herein. Further, the warm-up table can be generated offline by measuring execution values k times, which is the number of samples needed to generate the probability distribution. Thus, although the workload executions are performed to completion k times, k is smaller than the n times that would be performed by conventional reinforcement learning methods during training operations.

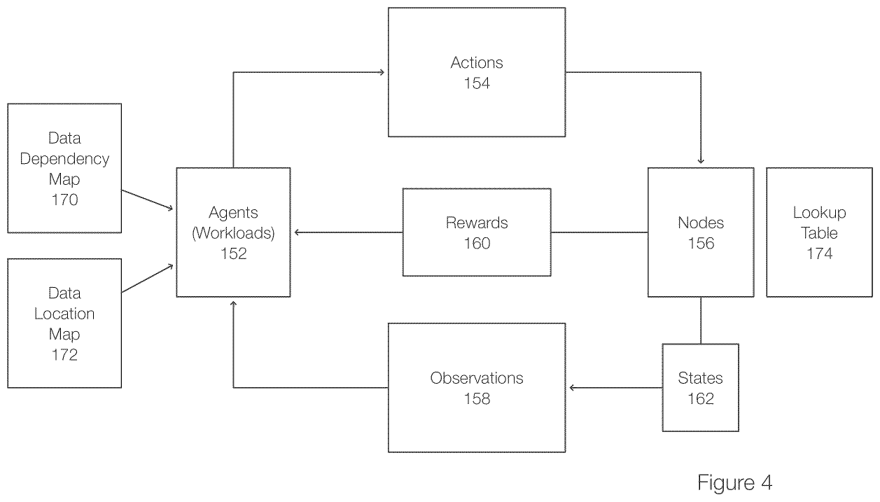

FIG. 4 discloses aspects of training a reinforcement learning model that accounts for data dependencies and/or data locations. FIG. 4 illustrates tensors (or datasets) including a data dependency map 170 and a data location map 172. The data dependency map 170 describes how datasets present in the computing environment (e.g., the nodes 156) are linked to workloads that may be allocated in the computing environment. The data location map 172 describes or identifies the location of each dataset across all of the nodes 156.

Both of the maps 170 and 172 are used to update the lookup table 174. The lookup table 174 includes information similar to the lookup table 164 along with dependency and/or location data. More specifically, the execution times in the lookup table 174 reflect time required to access/move data from one node to another node in addition to workload execution time at the node. The maps 170 and 172 allow the lookup table 174 to be used in training a reinforcement learning model such that data transfer times are considered and accounted for in the training operation. Thus, the reinforcement learning agent in FIG. 4 can be trained in the context of stateful workload executions in addition to accommodating stateless workload executions.

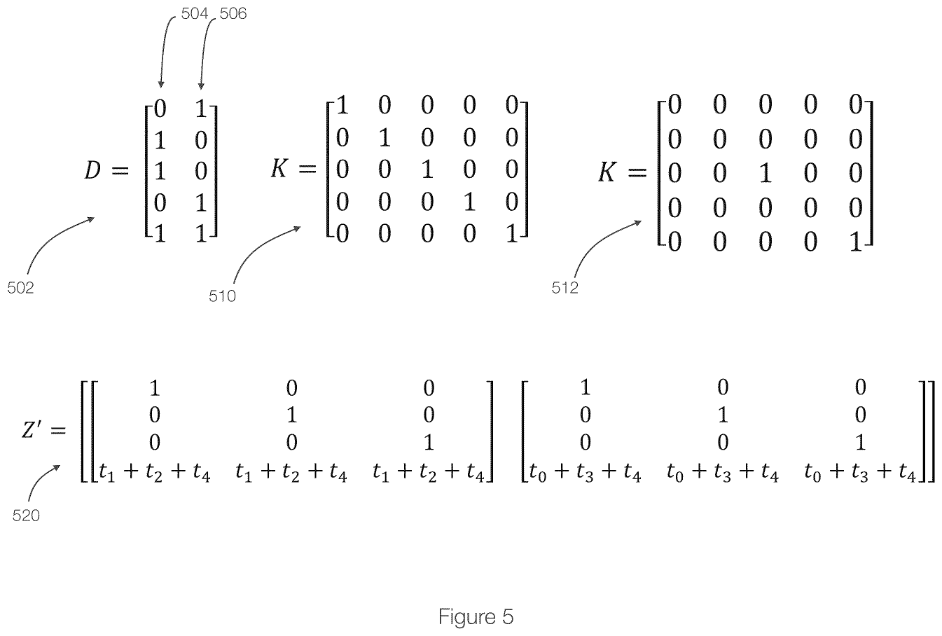

FIG. 5 discloses aspects of a data dependency map and a data location map. In one example, to represent the relationship between datasets and workloads, a data dependency map 502 is defined. In this example, the map 502 is a rank-2 tensor (matrix) given by D_{p×q}, where p is a number datasets and q is a number of workload types. For example, if there are five datasets (p=5) and two types of workloads (q=2), the data dependency map would be represented as the map 502.

In this example, the first column 504 represents the datasets required by workloads of type 0, which are d₁, d₂ and d₄. Similarly, the second column 506 of this example represents the datasets required by the workloads of type 1 (d₀, d₃ and d₄). The map 502 is static and node independent.

FIG. 5 also illustrates an example of a data location map 510. In this example, the map 510 is implemented as a binary tensor (K_{p×p} in this example). The map 510 is defined dynamically and encodes which datasets are available in or at a given node. For p=5 (5 datasets), for example, an example data location map 510 is illustrated.

The matrix or map 510 is a diagonal matrix where the bit is switched ON if the dataset is not present on a node. For example, in a node in which datasets 0, 1, and 3 are downloaded and available at a specific node, the data location map (K) of that specific node would be defined as the map 512.

Each of the nodes may be associated with a location map such as the map 510. More specifically, the map 510 is represented as a square matrix (or tensor) where the diagonal represents the presence or absence of a dataset with respect to a node. A zero (0) indicates that a dataset is present and a one (1) indicates that the dataset is not present at the node.

As previously indicated, another dimension in the map 510 may be considered because the map 510 (K) is defined per node in one example. In this case, K or the map 510 would be a rank-3 tensor with dimensionality (n×p×p), where n is the number of nodes and each slice of the tensor refers to a specific node. This tensor is always kept updated with the current location of a dataset in order to avoid unnecessary copying of data across the nodes in the computing environment.

The following discussion demonstrates use of the data dependency map and the data location map. These maps allows a data aware orchestrator (e.g., the placement engine 108) to orchestrate workloads in a data aware manner. In this example,

d={dᵢ}ᵢ₌₀^{p}.

d is a vector encoding the size of p datasets. Each entry encodes a size of the corresponding dataset.

Consider, without loss of generality, that there are five datasets as follows:

d=[d₀,d₁,d₂,d₃,d₄].

In this example, b, is or represents the bandwidth of a given node n. The time to transfer each dataset to this node is computed as follows:

$$T = ( \frac{1}{{b}_{n}} d ) = [ \frac{{d}_{0}}{{b}_{n}} , \frac{{d}_{1}}{{b}_{n}} , \frac{{d}_{2}}{{b}_{n}} , \frac{{d}_{3}}{{b}_{n}} , \frac{{d}_{4}}{{b}_{n}} ] .$$

T can be rewritten as follows:

T=[t₀,t₁,t₂,t₃,t₄].

In this example, t₁ corresponds to the time needed to transfer the i-th dataset to the node n.

The tensor encoding the extra time to deploy the data requirements (i.e., move the dataset to the node) of a workload is then given by:

$$Z = T \times K \times D .$$

In this example,

$$Z = [ {t}_{1} + {t}_{2} + {t}_{4} {t}_{0} + {t}_{3} + {t}_{4} ] .$$

The first column of Z corresponds to the extra data movement time (t₁+t₂+t₄) to run workloads of type 0 while the second column corresponds to the extra data movement time (t₀+t₃+t₄) to run workloads of type 1 when none of the workloads are already deployed at the node. If the dataset is already present at the node, the data movement or transfer time is zero.

In order to update the values directly inside the look-up table, each value in Z may be considered as the homogeneous coordinates of each column vector inside an identity matrix, leading to matrix or tensor 520 Z′ in FIG. 5.

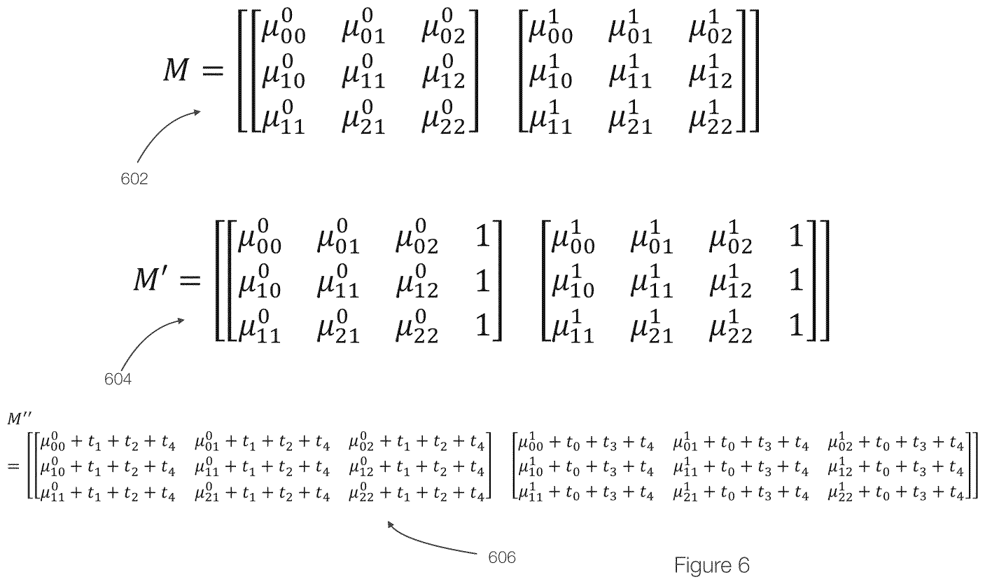

FIG. 6 discloses additional aspects of a lookup table for use at least in training machine learning models such as reinforcement learning models. FIG. 6 illustrates a lookup table 602 (e.g., tensor M), which is an example of the lookup table 164 or 166. The lookup table 602 represents or encodes execution times (e.g., mean execution times) of workloads considering their type and number of instances for a given node. By adding a homogeneous coordinate to each slice of the lookup table 602 and performing a transposing operation, an updated lookup table is represented as the lookup table 604 (M′). Using the lookup table 604, a lookup table 606 is generated that represents execution times and/or data transport or downloading times.

More specifically, the lookup table (or tensor) 606 is:

$${M}^{′′} = {M}^{′} * {Z}^{′} ,$$

where * represents the batch multiplication operation between tensors.

Thus, the lookup table 606 represents and includes mean or estimated execution times and mean or expected data movement or transfer times, or the like and can be used in training operations. This avoids the need, during training, to actually wait for datasets to be moved and for applications to be executed. This improvement in training time requirements is substantial.

By keeping only one tensor updated with the information about where the datasets are located, the execution time of all of the workloads can be re-estimated. As the workloads and datasets are deployed, the data location map (e.g., map 510) is updated and can be used along with the data dependency map (e.g., map 502). Additionally, the action space, the state space and the reward function may be kept the same in one example because new overall execution time (both data movement time and workload execution time) is now encoded in the look-up tensor 606. Thus, embodiments of the invention advantageously provide a method for training a model such as a reinforcement model in the context of stateful workloads and/or stateless workloads at a cost of linear tensor operations.

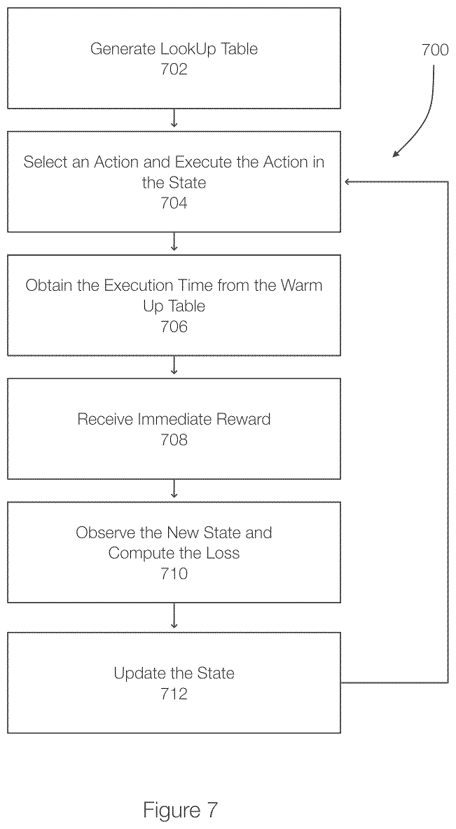

FIG. 7 discloses aspects of training a reinforcement learning model using a warm-up or lookup table. The method 700 may assume that the warm-up or lookup table (e.g., the lookup table 606) has been generated 702. The training steps or acts of the method 700 may be performed iteratively (e.g., n times). Thus, once the lookup table is generated, the training operation or method may begin. In one example, an action is selected and executed 704. For example, a placement engine, which may include a reinforcement model being trained, may recommend an allocation for a workload in a computing environment.

The execution time, which represents or accounts for data location and/or data dependency, is then obtained 706 from the warm-up or lookup table. Because the training method 700 does not need to wait for the workloads to be moved or executed, the reward is immediately received 708 or determined. Next, the new state is observed 710 and the loss is computed 710. The states are updated 712 and the next iterations are performed starting by selecting an action and executing the action according to the state or the environment.

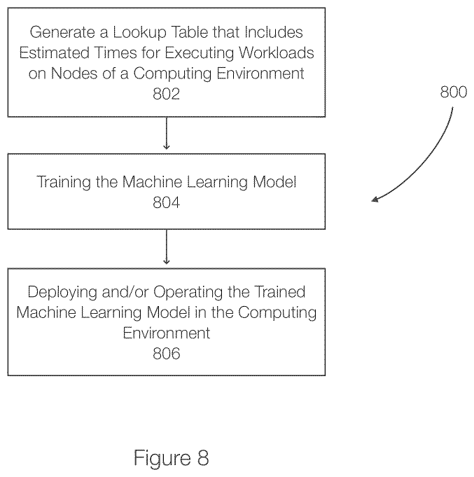

FIG. 8 discloses aspects of a method for training a reinforcement learning model to place or allocate workloads in a computing environment. The method 800 include generating 802 a lookup table that includes estimated time for executing workloads on nodes of a computing environment. The estimated time include an estimate of any time required to move or download datasets and estimates of workload execution times. The estimated times may be mean times based on a certain number of executions, based on calculations or expected bandwidth, or the like.

Next, the machine learning model or reinforcement learning model is trained 804. Training includes using the lookup table to access the relevant estimated time for the relevant node such that a reward can be generated. This process may repeat as rewards and state observations are used to determine subsequent actions during training.

Once trained, the model may be deployed 806. Thus, the trained machine learning or reinforcement learning model is operated in the environment to allocate workloads in the computing environment that may include nodes. The actions may include migrating/not migrating datasets and/or migrating/not migrating workloads.

The following is a discussion of aspects of example operating environments for various embodiments of the invention. This discussion is not intended to limit the scope of the invention, or the applicability of the embodiments, in any way.

In general, embodiments of the invention may be implemented in connection with systems, software, and components, that individually and/or collectively implement, and/or cause the implementation of, machine learning operations, reinforcement learning operation reinforcement learning training operations, table/tensor generation operations, operations for generating lookup tables that account for data movement and/or workload execution times, and the like. More generally, the scope of the invention embraces any operating environment in which the disclosed concepts may be useful.

New and/or modified data collected and/or generated in connection with some embodiments, may be stored in an environment that maitake the form of a public or private cloud storage environment, an on-premises storage environment, and hybrid storage environments that include public and private elements. Any of these example storage environments, may be partly, or completely, virtualized. The storage environment may comprise, or consist of, a datacenter which is operable to perform operations initiated by one or more clients or other elements of the operating environment.

Example cloud computing environments, which may or may not be public, include storage environments that may provide functionality for one or more clients. Another example of a cloud computing environment is one in which processing, machine learning, and other, services may be performed on behalf of one or more clients. Some example cloud computing environments in connection with which embodiments of the invention may be employed include, but are not limited to, Microsoft Azure, Amazon AWS, Dell EMC Cloud Storage Services, and Google Cloud. More generally however, the scope of the invention is not limited to employment of any particular type or implementation of cloud computing environment.

In addition to the cloud environment, the operating environment may also include one or more clients that are capable of collecting, modifying, and creating, data. As such, a particular client may employ, or otherwise be associated with, one or more instances of each of one or more applications that perform such operations with respect to data. Such clients may comprise physical machines, containers, or virtual machines (VMs).

Particularly, devices in the operating environment may take the form of software, physical machines, containers, or VMs, or any combination of these, though no particular device implementation or configuration is required for any embodiment. Similarly, data system components such as databases, storage servers, storage volumes (LUNs), storage disks, for example, may likewise take the form of software, physical machines, containers, or virtual machines (VMs), though no particular component implementation is required for any embodiment. Example embodiments of the invention are applicable to any system capable of storing and handling various types of objects, in analog, digital, or other form.

It is noted with respect to the disclosed methods, that any operation(s) of any of these methods, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

Following are some further example embodiments of the invention. These are presented only by way of example and are not intended to limit the scope of the invention in anyway.

Embodiment 1. A method comprising: generating a lookup table M″ for training a machine learning model, wherein the lookup table M″ includes estimated times for executing workloads on nodes of a computing environment, the times including estimated execution times and estimated data movement times, and training the machine learning model based on a set of actions, a state of the computing environment, and rewards, wherein the rewards used in the training are based on the estimated times in the lookup table.

Embodiment 2. The method of embodiment 1, wherein generating the lookup table comprises generating a data dependency map D that associates datasets with workload types and generating a data location map K, wherein the data location map K encodes datasets available at each node in the nodes, wherein the data dependency map D includes n columns for n workload types, wherein each of the columns identifies datasets required by the corresponding workload type.

Embodiment 3. The method of embodiment 1 and/or 2, further comprising generating a first tensor T that represents time to transfer each of the datasets to each of the nodes, wherein the time to transfer is based on sizes of the datasets and a bandwidth of each of the nodes in the computing environment.

Embodiment 4. The method of embodiment 1, 2, and/or 3, further comprising generating a time tensor Z=T×K×D.

Embodiment 5. The method of embodiment 1, 2, 3, and/or 4, further comprising generating the lookup table using an estimated execution time lookup table M such that M″=M′×Z′, wherein Z′ comprises a tensor Z having homogeneous coordinates of each column vector inside an identity matrix, and wherein M′ comprises an execution time lookup table M having a homogeneous coordinate added to each slice of M.

Embodiment 6. The method of embodiment 1, 2, 3, 4, and/or 5, further comprising transposing second and third dimensions of the execution time lookup table M after adding the homogeneous coordinate to each slice of M.

Embodiment 7. The method of embodiment 1, 2, 3, 4, 5, and/or 6, further comprising updating locations of the datasets such that the lookup table M″ is also updated.

Embodiment 8. The method of embodiment 1, 2, 3, 4, 5, 6, and/or 7, further comprising deploying the machine learning model, which is a reinforcement learning model, to the computing environment, wherein workloads are allocated using the reinforcement learning model.

Embodiment 9. The method of embodiment 1, 2, 3, 4, 5, 6, 7, and/or 8, wherein the estimated workload execution times include mean times for performing the workloads, wherein the estimated workload execution times account for multiple workload types and multiple workload instances on a node.

Embodiment 10. The method of embodiment 1, 2, 3, 4, 5, 6, 7, 8, and/or 9, wherein an observation space used to generate observations includes resource usage per virtual machine on each of the nodes, resource usage per workload, state of each workload, and time to finish each of the workloads.

Embodiment 11. A system, comprising hardware and/or software, operable to perform any of the operations, methods, or processes, or any portion of any of these, or any combination thereof disclosed herein.

Embodiment 12. A non-transitory storage medium having stored therein instructions that are executable by one or more hardware processors to perform operations comprising the operations of any one or more of embodiments 1-10.

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, component, engine, agent, or client may refer to software objects or routines that execute on the computing system. These may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

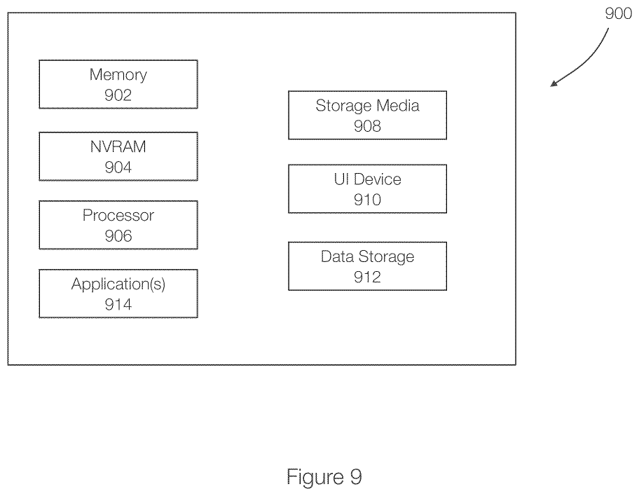

With reference briefly now to FIG. 9, any one or more of the entities disclosed, or implied by the Figures and/or elsewhere herein, may take the form of, or include, or be implemented on, or hosted by, a physical computing device, one example of which is denoted at 900. As well, where any of the aforementioned elements comprise or consist of a virtual machine (VM), that VM may constitute a virtualization of any combination of the physical components disclosed in FIG. 9.

In the example of FIG. 9, the physical computing device 900 includes a memory 902 which may include one, some, or all, of random access memory (RAM), non-volatile memory (NVM) 904 such as NVRAM for example, read-only memory (ROM), and persistent memory, one or more hardware processors 906, non-transitory storage media 908, UI device 910, and data storage 912. One or more of the memory components 902 of the physical computing device 900 may take the form of solid state device (SSD) storage. As well, one or more applications 914 may be provided that comprise instructions executable by one or more hardware processors 906 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method comprising:
generating a lookup table M″ for training a machine learning model, wherein the lookup table M″ includes estimated times for executing workloads on nodes of a computing environment, the times including estimated execution times and estimated data movement times; and
training the machine learning model based on a set of actions, a state of the computing environment, and rewards, wherein the rewards used in the training are based on the estimated times in the lookup table.

2. The method of claim 1, wherein generating the lookup table comprises generating a data dependency map D that associates datasets with workload types and generating a data location map K, wherein the data location map K encodes datasets available at each node in the nodes, wherein the data dependency map D includes n columns for n workload types, wherein each of the columns identifies datasets required by the corresponding workload type.

3. The method of claim 2, further comprising generating a first tensor T that represents time to transfer each of the datasets to each of the nodes, wherein the time to transfer is based on sizes of the datasets and a bandwidth of each of the nodes in the computing environment.

4. The method of claim 3, further comprising generating a time tensor Z=T×K×D.

5. The method of claim 4, further comprising generating the lookup table using an estimated execution time lookup table M such that M″=M′×Z′, wherein Z′ comprises a tensor Z having homogeneous coordinates of each column vector inside an identity matrix, and wherein M′ comprises an execution time lookup table M having a homogeneous coordinate added to each slice of M.

6. The method of claim 5, further comprising transposing second and third dimensions of the execution time lookup table M after adding the homogeneous coordinate to each slice of M.

7. The method of claim 1, further comprising updating locations of the datasets such that the lookup table M″ is also updated.

8. The method of claim 1, further comprising deploying the machine learning model, which is a reinforcement learning model, to the computing environment, wherein workloads are allocated using the reinforcement learning model.

9. The method of claim 1, wherein the estimated workload execution times include mean times for performing the workloads, wherein the estimated workload execution times account for multiple workload types and multiple workload instances on a node.

10. The method of claim 1, wherein an observation space used to generate observations includes resource usage per virtual machine on each of the nodes, resource usage per workload, state of each workload, and time to finish each of the workloads.

11. A non-transitory storage medium having stored therein instructions that are executable by one or more hardware processors to perform operations comprising:
generating a lookup table M″ for training a machine learning model, wherein the lookup table M″ includes estimated times for executing workloads on nodes of a computing environment, the times including estimated execution times and estimated data movement times; and
training the machine learning model based on a set of actions, a state of the computing environment, and rewards, wherein the rewards used in the training are based on the estimated times in the lookup table.

12. The non-transitory storage medium of claim 11, wherein generating the lookup table comprises generating a data dependency map D that associates datasets with workload types and generating a data location map K, wherein the data location map K encodes datasets available at each node in the nodes, wherein the data dependency map D includes n columns for n workload types, wherein each of the columns identifies datasets required by the corresponding workload type.

13. The non-transitory storage medium of claim 12, further comprising generating a first tensor T that represents time to transfer each of the datasets to each of the nodes, wherein the time to transfer is based on sizes of the datasets and a bandwidth of each of the nodes in the computing environment.

14. The non-transitory storage medium of claim 13, further comprising generating a time tensor Z=T×K×D.

15. The non-transitory storage medium of claim 14, further comprising generating the lookup table using an estimated execution time lookup table M such that M″=M′×Z′, wherein Z′ comprises a tensor Z having homogeneous coordinates of each column vector inside an identity matrix, and wherein M′ comprises an execution time lookup table M having a homogeneous coordinate added to each slice of M.

16. The non-transitory storage medium of claim 15, further comprising transposing second and third dimensions of the execution time lookup table M after adding the homogeneous coordinate to each slice of M.

17. The non-transitory storage medium of claim 11, further comprising updating locations of the datasets such that the lookup table M″ is also updated.

18. The non-transitory storage medium of claim 11, further comprising deploying the machine learning model, which is a reinforcement learning model, to the computing environment, wherein workloads are allocated using the reinforcement learning model.

19. The non-transitory storage medium of claim 11, wherein the estimated workload execution times include mean times for performing the workloads, wherein the estimated workload execution times account for multiple workload types and multiple workload instances on a node.

20. The non-transitory storage medium of claim 11, wherein an observation space used to generate observations includes resource usage per virtual machine on each of the nodes, resource usage per workload, state of each workload, and time to finish each of the workloads.
